(19) United States
(12) Patent Application Publication
(10) Pub. No.: US 2008/0239281 A1
(43) Pub. Date: Oct. 2, 2008

(54) ABSOLUTE DISTANCE METER

(75) Inventor: Robert E. Bridges, Kennett Square, PA (US)

Correspondence Address: CANTOR COLBURN, LLP, 20 Church Street, 22nd Floor, Hartford, CT, 06103, US

(73) Assignee: FARO TECHNOLOGIES, INC., Lake Mary, FL (US)

(21) Appl. No.: 12/058,904

(22) Filed: Mar. 31, 2008

Related U.S. Application Data
(60) Provisional application No. 60/909,099, filed on Mar. 30, 2007.

(51) Int. Cl. G01C 3/08

(52) U.S. Cl. 356/5.09

(57) ABSTRACT

An absolute distance meter for measuring a distance to a target may include a synthesizer including a first quadrature modulator and structured to receive a reference signal having a reference frequency and output a first signal having a first frequency and a second signal having a second frequency, a laser structured to output a laser beam, wherein the laser beam is modulated by the second signal, an optical system for directing the laser beam toward the target, a reference phase calculating system structured to calculate a reference phase based on signals having the first frequency and the second frequency, a target optical detector structured to receive at least a portion of the laser beam returned from the target and structured to output a measured electrical signal having the second frequency based on the at least a portion of the laser beam, and a measure phase calculating system structured to calculate a measure phase based on the measured electrical signal and the first signal.

### CROSS REFERENCE TO RELATED APPLICATIONS

This application claims priority to U.S. Provisional Application No. 60/909,099 filed Mar. 30, 2007, the entire contents of which are incorporated herein by reference.

### BACKGROUND

The present disclosure relates to a device capable of making absolute distance measurements. As instrument capable of absolute distance measurement is distinguished from one that measures incremental distance in that it can immediately measure distance to a target of interest even if the beam path has been broken. Another way of saying this is that an absolute distance measuring device can immediately measure distance to a target at an arbitrary location. The target may be a cooperative target such as a retroreflector or a non-cooperative target such as a diffuse surface.

One method of measuring absolute distance is to modulate laser light, send the light to a remote target, detect it upon return, and determine its phase of modulation. The phase of the returning laser light, which is called the measure phase, is compared to a reference phase, which is derived either from an electrical or optical signal from within the instrument. The difference in the measure and reference phases is used to calculate the distance to the target.

To measure the phase of a modulated signal following optical detection, one technique that can be used is to create another frequency, referred to as the LO frequency, that is mixed with the laser modulation frequency, referred to as the radio frequency (RF). After filtering, the result of the mixing process is to produce a frequency, called the intermediate frequency (IF), whose value is equal to difference in the LO and radio frequencies. This IF is sampled in an analog-to-digital converter (ADC) an integer number of times per cycle. The numerical values from the ADC are sent to a processing device that uses a single-point Digital Fourier Transform (DFT) algorithm or its equivalent to find the phase of the measure and reference signals.

The chief complexity in this approach is generating two frequencies, the LO and radio frequencies, that are relatively close in value so that the IF is small enough so to permit reasonably small sampling rate for the ADC. Furthermore, the signals must be generated in a way that avoids generation of spurious signals that can corrupt the measurement results. One method that has been used for generating two closely spaced frequencies is with a double phase-locked loop (PLL) approach; however, this approach requires a complex design. A second method is to use a series of mixers to upconvert two baseband signals of slightly different frequency to two much higher frequencies having the same slight frequency difference. The main disadvantage of this approach is that it requires numerous mixers and filters, all of which must be shielded from one another to prevent crosstalk. The resulting assembly is relatively large and complicated. A third method uses a quadrature modulator to generate a single sideband signal. By carefully adjusting the phase, offset, and amplitude of the low-frequency signals that are applied to the quadrature modulator, it is possible to ensure that the modulator will reject the unwanted sideband and carrier by approximately 50 dB. However, for optimum performance of an ADM system, this rejection should be at least 70 dB and preferably 90 dB.

What is needed is an absolute distance meter that measures phase by a simplified method that neither has the complexity of the dual-PLL or multiple-mixer approach nor the performance shortcomings of the quadrature-modulator approach.

### SUMMARY OF THE INVENTION

At least an embodiment of an absolute distance meter for measuring a distance to a target may include a synthesizer comprising a first quadrature modulator and structured to receive a reference signal having a reference frequency and output a first signal having a first frequency and a second signal having a second frequency, a laser structured to output a laser beam, wherein the laser beam is modulated by the second signal, an optical system for directing the laser beam toward the target, a reference phase calculating system structured to calculate a reference phase based on signals having the first frequency and the second frequency, a target optical detector structured to receive at least a portion of the laser beam returned from the target and structured to output a measured electrical signal having the second frequency based on the at least a portion of the laser beam, and a measure phase calculating system structured to calculate a measure phase based on the measured electrical signal and the first signal.

At least an embodiment of a synthesizer for use in an absolute distance meter may include a phase locked loop structured to receive a reference signal having a reference frequency and output a phase locked loop signal having a phase locked loop frequency, a first signal generator structured to output a first generated signal having a first generated frequency, a second signal generator structured to output a second generated signal having a second generated frequency, a first quadrature modulator structured to receive the phase locked loop signal and the first generated signal and structured to output a first sideband signal, and a second quadrature modulator structured to receive the phase locked loop signal and the second generated signal and structured to output a second sideband signal, wherein the phase locked loop frequency is higher than the reference frequency, and the first generated frequency and the second generated frequency differ by a predetermined intermediate frequency.

At least an embodiment of a method of making an absolute distance measurement of a target may include generating a first signal having a first frequency and a second signal having a second frequency using a first quadrature modulator, outputting a laser beam from a laser, wherein the laser beam is modulated by the second signal, directing the laser beam to the target, detecting at least a portion of the laser beam returned from the target and generating a measured electrical signal having the second frequency based on the at least a portion of the laser beam, calculating a measure phase based on the measured electrical signal and the first signal, calculating a reference phase based on signals having the first frequency and the second frequency, determining the absolute distance measurement based on a difference between the reference phase and the measure phase.

At least an embodiment of a method of generating sideband signals may include receiving a reference signal having a reference frequency in a phase locked loop, generating a phase locked loop signal having a phase locked loop frequency, generating a first generated signal having a first generated frequency, generating a second generated signal having a second generated frequency, receiving the phase locked loop signal and the first generated signal in a first quadrature modulator, receiving the phase locked loop signal and the second generated signal in a second quadrature modulator, outputting a first sideband signal from the first quadrature modulator based on the phase locked loop signal and the first generated signal, and outputting a second sideband signal from the second quadrature modulator based on the phase locked loop signal and the second generated signal, wherein the phase locked loop frequency is higher than the reference frequency, and the first generated frequency and the second generated frequency differ by a predetermined intermediate frequency.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1 is a block diagram of an exemplary measuring device and system; and

FIG. 2 is a block diagram view of the synthesizer components and the signal frequencies that are generated.

### DETAILED DESCRIPTION OF THE PREFERRED EMBODIMENTS

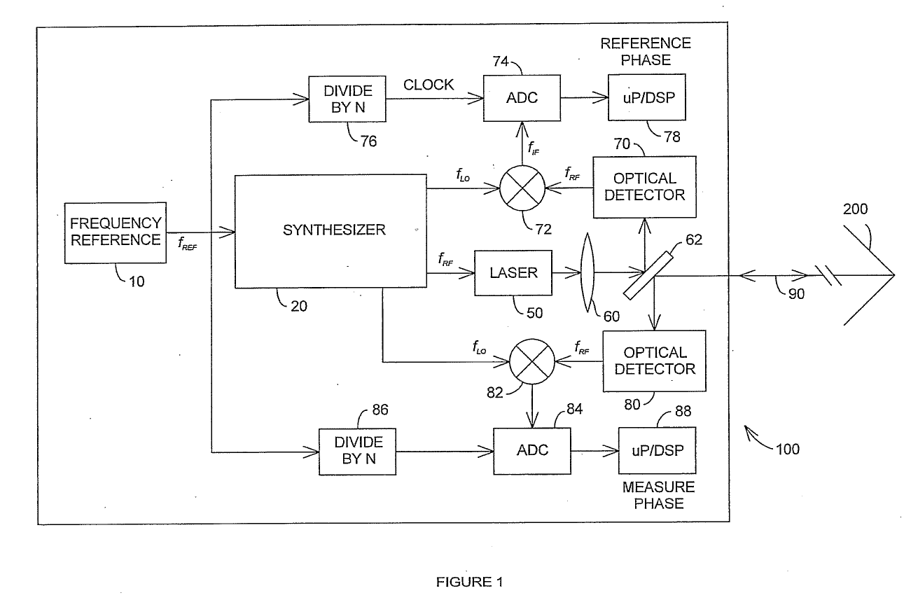

As shown in FIG. 1, ranging device 100 comprises frequency reference 10, synthesizer 20, laser 50, collimating lens 60, beam-splitting means 62, optical detectors 70, 80, mixers 72, 82, analog-to-digital converters (ADCs) 74, 84, and divide-by-N function 76, 86. Frequency reference 10, which is preferably an oven controlled crystal oscillator (OCXO), sends a high stability signal of frequency f_{REF} to synthesizer 20. Synthesizer 20 produces signals at frequencies f_{LO} and f_{RF}. The signal with frequency f_{REF} is an example of a reference signal having a reference frequency. The signal with frequency f_{LO} is one example of a first signal having a first frequency, and the signal at frequency f_{RF} is an example of a second signal having a second frequency.

The signal at frequency f_{RF} modulates some characteristic of laser 50, preferably the optical power of the laser beam. This type of modulation is commonly known as intensity modulation. Laser beam 90 passes through collimating lens 60. A first part of this laser beam, i.e., a target beam, then passes through beam splitting means 62 and travels to target 200. On the return path, the laser beam is redirected by beam-splitting means 62 to strike optical detector 80. A second part of laser beam 90 from collimator lens 60, i.e., a reference beam, is directed by beam-splitting means 62 to optical detector 70. Hence that portion of the laser beam received by optical detector 80 has made a round trip to target 200, while that portion received by optical detector 70 has remained within the ranging device 100. Beam-splitting means 62 may be made of glass, as illustrated in FIG. 1, or it may be a fiber optic assembly comprising one or more fiber splitters or similar devices.

The electrical signals from optical detectors 70 and 80 contain the frequency f_{RF}. It will be understood that by a signals “containing” or “having” the frequency f_{RF} does not necessarily mean that these signals contain only frequency f_{RF}. For example, it will be understood that the signals may include other frequencies that may be excluded. These signals pass into mixers 72 and 82, respectively. Mixer 72 is one possible example of a reference mixer and mixer 82 is one possible example of a target mixer. The signal at frequency f_{LO} from synthesizer 20 enters mixers 72, 82. The function of the two mixers is to produce sum and differences frequencies. The higher of these two frequencies is filtered out, either by a filter specifically created for this purpose or incidentally as a result of bandwidth limitations of the components that follow the mixer. The lower of the two frequencies that leaves the mixer is the intermediate frequency (IF), which is equal to f_{IF}=|f_{LO}−f_{RF}|. In other words, the mixers 72, 82 output an intermediate signal having an intermediate frequency. The IF is sent to the analog-to-digital converter (ADC), where it is sampled at the rate of the clock that is derived from the frequency reference by passing through the divide-by-N component. The rate of the sample clock is equal to a multiple of the intermediate frequency f_{IF}.

The digital samples that are output from ADCs 74, 84 are sent to processing device 78, 88, which are preferably a microprocessor (uP) or digital signal processing (DSP) chip. The devices 78 and 88 are preferably combined in one electrical chip. Processing devices 78, 88 perform calculations to the phase of the IF signals from mixers 72, 82. Generally these calculations are based on the discrete Fourier transform (DFT) and are selected to efficiently extract the phase of the signal received by the ADC. Processors 72, 82 are said to extract the reference phase and measure phase, respectively. The difference phase is obtained by subtracting the reference phase from the measure phase. The phase is divided by 2π and the result is multiplied by the ambiguity interval to determine the relative distance traveled within that ambiguity interval. The relative distance traveled can be determined by a distance calculator such as a processor or any other suitable device or structure. The ambiguity interval is defined as the speed of light in vacuum divided by twice the product of the modulation frequency and the group index of refraction of air. If more than one ambiguity interval is present, then another must be provided to establish which ambiguity interval the target is in. This is usually done by providing one or more additional modulation frequencies to the laser. These modulation frequencies may be applied sequentially or simultaneously depending on the particular measurement requirements. In addition, prior to first use of absolute distance meter 100, a compensation procedure is performed to determine compensation parameters. These compensation parameters usually include a phase offset term and may also include cyclic or intensity correction terms.

In FIG. 1, the reference phase calculated by processor 78 is based on the phase the modulated laser light output from optical detector 70. An alternative is to apply radio frequency f_{RF} directly to mixer 72 without first undergoing conversion to light in laser 50 and conversion back to electricity in optical detector 70. In other words, a mixing signal is applied to mixer 72. Each of the two alternative approaches has its merits. The approach shown in FIG. 1 has the advantage of eliminating common-mode laser noise. The all-electrical approach, on the other hand, reduces size and cost.

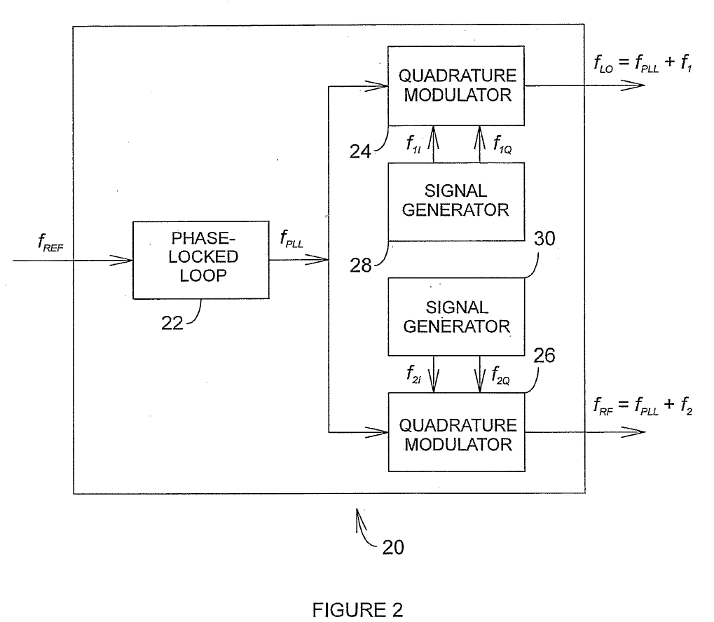

Synthesizer 20 shown in FIG. 2 comprises phase-locked loop (PLL) 22, signal generators 28, 30, and quadrature modulators 24, 26. Phase-locked loop 22 receives a signal at frequency f_{REF} from frequency source 10 and generates a signal at a much higher frequency f_{PLL}. In other words, the signal at frequency f_{PLL} can be one example of a phase locked loop signal having a phase locked loop frequency. As an example, f_{REF} may be 20 MHz and f_{PLL} may be 2560 MHz. Signal generators 28, 30 generate signals f₁, f₂, i.e., first and second generated signals whose frequencies are separated by the desired IF. For example, if the desired f_{IF} is 10 kHz, then the frequencies created by signal generators 28, 30 might be f₁=5.005 MHz and f₂=4.995 MHz. FIG. 1 shows that there are two signals f₁ called f_{1I} and f_{1Q} and two signals f₂ called f_{2I} and f_{2Q}. The subscripts I and Q in these symbols refer to in-phase (0 degrees) and quadrature (90 degrees), respectively. In other words, the signals f_{1I} and f_{1Q} have the same frequency but differ in phase by approximately 90 degrees.

The purpose of quadrature modulators 24, 26 is to produce single sideband signals f_{LO} and f_{RF}, respectively. In FIG. 2, the single sideband signals have frequencies that are equal to the sum of the PLL and signal-generator frequencies. This frequency component is said to be the upper sideband. The lower sideband, which has a frequency equal to the difference of the PLL and signal-generator frequencies, could equally well have been selected. It is desirable that the unwanted sideband and the carrier component, whose frequency is equal to f_{PLL}, be as small as possible. Another way of saying this is that the rejection of the undesired sideband and carrier signal should be as high as possible. To maximize rejection of the unwanted sidebands and carrier, the characteristics of the signals from signal generators 28, 30 are manipulated to give the ideal phase difference, sinusoidal amplitude, and DC offset between the I and Q components that are put into quadrature modulators 24, 26. These ideal values have been achieved when the unwanted sideband and carrier in the output signal are shown on an RF spectrum analyzer to be as small as possible. If the signals from signal generators 28, 30 are properly adjusted for phase, amplitude, and offset, the unwanted sideband and carrier should be approximately 50 dB or more below the desired sideband.

It is possible to obtain the desired IF (for example, 10 kHz) by using a single quadrature modulator. For example, it would be possible to use the quadrature modulator to generate a single sideband signal for the LO and the phase-locked-loop signal only to modulate laser 50. In this case, f_{LO}=f_{PLL} and f_{RF}=f_{PLL}+f₂. However, the mixing product f_{IF} from mixers 72, 82 will then have unwanted sideband and carrier signals that are only approximately 50 dB smaller than the desired signal. Consequently, cyclic errors are larger and measurements noisier than desired.

These problems are avoided by adding a second quadrature modulator, as shown in FIG. 2. As a specific example, suppose that the PLL frequency is f_{PLL}=2560 MHz and the signal generator frequencies are f₁=5.005 MHz and f₂=4.995 MHz. Assuming that the upper sidebands are desired, the resulting LO and radio frequencies are then f_{LO}=f_{PLL}+f₁=2565.005 MHz and f_{RF}=f_{PLL}+f₂=2564.995 MHz. When these signals pass through mixers 72, 82, the resulting difference frequency is f_{IF}=10 kHz. The unwanted sidebands will have frequencies 2555.005 MHz and 2554.995 MHz. These unwanted sidebands can mix with one another, but because each is down by 50 dB, the mixing product will be down by 100 dB, which is not a problem. These unwanted sidebands can also mix with the desired sidebands, but then the frequency difference is approximately 10 MHz, which is easily filtered out from the desired 10 kHz signal.

By using two quadrature modulators as shown in FIG. 2, it is possible to obtain a compact and low-cost absolute distance meter that has low cyclic error and low noise.

While preferred embodiments have been shown and described, various modifications and substitutions may be made thereto without departing from the spirit and scope of the invention. Accordingly, it is to be understood that the present invention has been described by way of illustrations and not limitation.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An absolute distance meter for measuring a distance to a target, the absolute distance meter comprising:
a synthesizer comprising a first quadrature modulator and structured to receive a reference signal having a reference frequency and output a first signal having a first frequency and a second signal having a second frequency;
a laser structured to output a laser beam, wherein the laser beam is modulated by the second signal;
an optical system for directing the laser beam toward the target;
a reference phase calculating system structured to calculate a reference phase based on signals having the first frequency and the second frequency;
a target optical detector structured to receive at least a portion of the laser beam returned from the target and structured to output a measured electrical signal having the second frequency based on the at least a portion of the laser beam; and
a measure phase calculating system structured to calculate a measure phase based on the measured electrical signal and the first signal.

2. The absolute distance meter of claim 1, wherein the synthesizer further comprises:
a phase locked loop structured to receive the reference signal and output a phase locked loop signal having a phase locked loop frequency;
a first signal generator structured to output a first generated signal having a first generated frequency;
a second signal generator structured to output a second generated signal having a second generated frequency; and
a second quadrature modulator structured to receive the phase locked loop signal and the second generated signal and structured to output the second signal;
wherein the first quadrature modulator is structured to receive the phase locked loop signal and the first generated signal and structured to output the first signal
the phase locked loop frequency is higher than the reference frequency; and
the first generated frequency and the second generated frequency differ by a predetermined intermediate frequency.

3. The absolute distance meter of claim 1, further comprising:
a frequency reference signal generator structured to output the reference signal.

4. The absolute distance meter of claim 3, wherein the frequency reference signal generator is an oven controlled crystal oscillator.

5. The absolute distance meter of claim 1, wherein the optical system comprises a collimating lens.

6. The absolute distance meter of claim 1, wherein the signals having the first frequency and the second frequency comprise the first signal and the second signal.

7. The absolute distance meter of claim 1, wherein the optical system comprises a beam splitting apparatus structured to split the laser beam into a reference beam and a target beam;
the beam splitting apparatus is structured to direct the reference beam to a reference optical detector;
the beam splitting apparatus is structured to direct the target beam to the target;
the reference optical detector is structured to detect the reference beam and output a signal having the second frequency;
the signals having the first frequency and the second frequency comprise the first signal and the signal having the second frequency generated by the reference optical detector.

8. The absolute distance meter of claim 1, wherein the measure phase calculating system comprises:
a target mixer structured to receive the first signal and the measured electrical signal and structured to output a target intermediate signal having an intermediate frequency;
a target analog-to-digital converter structured to receive the target intermediate signal and the reference signal, generate digital samples by sampling the target intermediate signal at a clock rate derived from the reference frequency, and output the digital samples; and
a processing device structured to extract the measure phase from the digital samples.

9. The absolute distance meter of claim 1, wherein the reference phase calculating system comprises:
a reference mixer structured to receive the signals having the first frequency and the second frequency and structured to output a reference intermediate signal having an intermediate frequency;
a reference analog-to-digital converter structured to receive the reference intermediate signal and the reference signal, generate digital samples by sampling the reference intermediate signal at a clock rate derived from the reference frequency, and output the digital samples; and
a processing device structured to extract the reference phase from the digital samples.

10. A synthesizer for use in an absolute distance meter, the synthesizer comprising:
a phase locked loop structured to receive a reference signal having a reference frequency and output a phase locked loop signal having a phase locked loop frequency;
a first signal generator structured to output a first generated signal having a first generated frequency;
a second signal generator structured to output a second generated signal having a second generated frequency;
a first quadrature modulator structured to receive the phase locked loop signal and the first generated signal and structured to output a first sideband signal; and
a second quadrature modulator structured to receive the phase locked loop signal and the second generated signal and structured to output a second sideband signal;
wherein the phase locked loop frequency is higher than the reference frequency; and
the first generated frequency and the second generated frequency differ by a predetermined intermediate frequency.

11. A method of making an absolute distance measurement of a target, the method comprising:
generating a first signal having a first frequency and a second signal having a second frequency using a first quadrature modulator;
outputting a laser beam from a laser, wherein the laser beam is modulated by the second signal;
directing the laser beam to the target;
detecting at least a portion of the laser beam returned from the target and generating a measured electrical signal having the second frequency based on the at least a portion of the laser beam;
calculating a measure phase based on the measured electrical signal and the first signal;
calculating a reference phase based on signals having the first frequency and the second frequency;
determining the absolute distance measurement based on a difference between the reference phase and the measure phase.

12. The method of claim 11, wherein the generating a first signal having a first frequency and a second signal having a second frequency comprises:
receiving a reference signal having a reference frequency in a phase locked loop;
generating a phase locked loop signal having a phase locked loop frequency;
generating a first generated signal having a first generated frequency;
generating a second generated signal having a second generated frequency;
receiving the phase locked loop signal and the first generated signal in the first quadrature modulator;
receiving the phase locked loop signal and the second generated signal in a second quadrature modulator;
outputting the first signal from the first quadrature modulator based on the phase locked loop signal and the first generated signal; and
outputting the second signal from the second quadrature modulator based on the phase locked loop signal and the second generated signal;
wherein the phase locked loop frequency is higher than the reference frequency; and
the first generated frequency and the second generated frequency differ by a predetermined intermediate frequency.

13. The method of claim 11, wherein the signals having the first frequency and the second frequency comprise the first signal and the second signal.

14. The method of claim 11, wherein
directing the laser beam to the target comprises:
splitting the laser beam into a reference beam and a target beam;
directing the reference beam to a reference optical detector that detects the reference beam and outputs a signal having the second frequency;
directing the target beam to the target; and
the signals having the first frequency and the second frequency comprise the first signal and the signal having the second frequency generated by the reference optical detector.

15. The method of claim 11, wherein calculating a measure phase based on the measured electrical signal and the first signal comprises:
mixing the first signal and the measured electrical signal and generating a target intermediate signal having an intermediate frequency;
sampling the target intermediate signal at a clock rate derived from a reference frequency to generate digital samples;
extracting the measure phase from the digital samples.

16. The method of claim 11, wherein calculating a reference phase based on the signals having the first frequency and the second frequency comprises:
mixing the signals having the first frequency and the second frequency and generating a reference intermediate signal having an intermediate frequency;
sampling the reference intermediate signal at a clock rate derived from a reference frequency to generate digital samples;
extracting the reference phase from the digital samples.

17. The method of claim 11, wherein determining the absolute distance measurement based on a difference between the reference phase and the measure phase comprises:
dividing the difference between the reference phase and the measure phase by 2π and multiplying the result by an ambiguity interval;
wherein the ambiguity interval is defined as the speed of light in vacuum divided by twice the product of the second frequency and the group index of refraction of air.

18. A method of generating sideband signals, the method comprising:
receiving a reference signal having a reference frequency in a phase locked loop;
generating a phase locked loop signal having a phase locked loop frequency;
generating a first generated signal having a first generated frequency;
generating a second generated signal having a second generated frequency;
receiving the phase locked loop signal and the first generated signal in a first quadrature modulator;
receiving the phase locked loop signal and the second generated signal in a second quadrature modulator;
outputting a first sideband signal from the first quadrature modulator based on the phase locked loop signal and the first generated signal; and
outputting a second sideband signal from the second quadrature modulator based on the phase locked loop signal and the second generated signal;
wherein the phase locked loop frequency is higher than the reference frequency; and
the first generated frequency and the second generated frequency differ by a predetermined intermediate frequency.

19. The absolute distance meter of claim 1, further comprising a distance calculator structured to determine the distance based on a difference between the reference phase and the measure phase.

20. The absolute distance meter of claim 19, wherein the distance calculator is structured to divide the difference between the reference phase and the measure phase by 2π and multiply the result by an ambiguity interval;
wherein the ambiguity interval is defined as the speed of light in vacuum divided by twice the product of the second frequency and the group index of refraction of air.
